(19) United States
(12) Patent Application Publication
(10) Pub. No.: US 2009/0290564 A1
(43) Pub. Date: Nov. 26, 2009

(54) APPARATUS FOR AND METHOD OF SUPPORTING NETWORK-BASED MOBILITY FOR DUAL STACK NODES

(75) Inventors: Myung-Ki Shin, Daejeon-city (KR); Sangjin Jeong, Daejeon-city (KR); Youn-Hee Han, Daejeon-city (KR); Hyoung-Jun Kim, Daejeon-city (KR)

Correspondence Address: RABIN & Berdo, PC, 1101 14TH STREET, NW, SUITE 500, WASHINGTON, DC, 20005, US

(73) Assignees: Electronics and Telecommunications Research Institute, Daejeon-city (KR); Center for University-Industry Corporation, Cheonan-city, chungcheongnam-do (KR)

(21) Appl. No.: 12/305,634

(22) PCT Filed: Jun. 13, 2007
(86) PCT No.: PCT/KR2007/002856

§ 371 Date: Dec. 18, 2008

(30) Foreign Application Priority Data
Jun. 19, 2006 (KR) 10-2006-0054908
Dec. 7, 2006 (KR) 10-2006-0124147

(51) Int. Cl. H04W 4/00; H04L 12/66

(52) U.S. Cl. 370/338; 370/401

(57) ABSTRACT

An apparatus for and method of supporting network-based mobility for a dual stack terminal are provided. More particularly, a mobile anchor point (MAP) apparatus for binding and data transmission of a dual stack terminal which has moved from a dual network to an Internet Protocol version 4 (IPv4) network or an Internet Protocol version 6 (IPv6) network, and a method of implementing the MAP apparatus are provided. If the IPv6, which is a next-generation Internet protocol, begins to be applied to networks, a dual stack terminal supporting both the IPv4 and IPv6 will also be introduced. In an environment in which this dual stack terminal moves, movement of the dual stack terminal to an IPv4-only network or an IPv6-only network as well as movement between IPv4/IPv6 dual networks will be considered. According to the apparatus and method, a MAP used in a conventional network-based mobility supporting method is extended. Accordingly, when a dual stack terminal moves between different network-based localized mobility management domains, such as an IPv4-only network or an IPv6-only network, a binding management message is made to be exchanged between two MAPs of the networks, thereby establishing an IPv6-in-IPv4 tunnel or an IPv4-in-IPv6 tunnel between the two MAPs. In this way, even when the dual stack terminal moves to an IPv4-only network or an IPv6-only network, communication with an external terminal is enabled.

### TECHNICAL FIELD

The present invention relates to an apparatus for and method of supporting network-based mobility for a dual stack terminal, and more particularly, to a mobility anchor point (MAP) apparatus for binding and transmitting data to a dual stack terminal which has moved to an Internet Protocol version 4 (IPv4) network or an Internet Protocol version 6 (IPv6) network.

### BACKGROUND ART

If Internet Protocol version 6 (IPv6), which is a next-generation Internet protocol, begins to be applied to networks, a dual stack terminal supporting both the IPv4 and IPv6 will be introduced. Dual stack technology is a technology for processing both the IPv4 and IPv6 protocols at the same time in one system (a host or a router). A system supporting dual stack technology is physically one system but operates as if two systems supporting IPv4 and IPv6 protocols exist logically. A terminal supporting this dual stack technology is referred to as a dual stack terminal.

Due to users' demands for high quality Internet services, improvement of the performance of mobile terminals, such as portable computers and personal digital assistant (PDAs), development of wireless communication technologies, increasing wireless uses, and availability of mobility for next-generation terminals, mobile IPv4 and IPv6 protocols supporting mobility have been introduced as the number of mobile terminals and home appliances on home networks has increased.

Accordingly, if a dual stack terminal is introduced, an environment in which this dual stack terminal moves will also be considered. When a dual stack terminal moves, movement to an IPv4-only network or an IPv6-only network as well as movement between IPv4/IPv6 dual networks, may also be considered.

In the movement of the dual stack terminal, a conventional network-based supporting method cannot support mobility of the dual stack terminal to an IPv4-only network or an IPv6-only network. This is because the conventional network-based mobility supporting method allows only an IPv4 terminal to move to an IPv4-only network, and allows only an IPv6 terminal to move to an IPv6-only network. Accordingly, the conventional network-based mobility supporting method cannot support IP connectivity for a terminal supporting an IPv4/IPv6 dual stack, when the terminal freely moves to an IPv4-only network or an IPv6-only network.

### DISCLOSURE OF INVENTION

### Technical Problem

The present invention provides an apparatus for and method of supporting network-based mobility for a dual stack terminal which moves from one network to another network.

### Technical Solution

According to the present invention, a mobility anchor point (MAP) used in a conventional network-based mobility supporting method is extended and named as a global MAP (GMAP). When a mobile node moves between different network-based localized mobility management domains, such as an IPv4-only network or an IPv6-only network, a binding management message is made to be exchanged between two MAPs of the networks, thereby maintaining a binding cache, including information on the mobile node, between the GMAP and the MAP of the network to which the mobile node has moved, and connecting data transmitted to the GMAP through IPv6-in-IPv4 tunneling or IPv4-in-IPv6 tunneling to the MAP. In this way, even when the dual stack terminal moves from one network to another network, such as an IPv4-only network or an IPv6-only network, communication with an external terminal is enabled.

According to an aspect of the present invention, there is provided mobility anchor point (MAP) apparatus for supporting mobility of a dual stack terminal when the dual stack terminal moves from one network to which the dual stack terminal belonged to another network, the MAP apparatus including a storage unit storing binding information, including information on the dual stack terminal after the moving and information on an access router to which the dual stack terminal belongs, which is received from a first MAP, which is a MAP for the network to which the dual stack terminal has moved; and a transmission unit, which when data to be transmitted to the dual stack terminal is received, transmits the received data to the first MAP based on the binding information on the dual stack terminal stored in the storage unit.

According to another aspect of the present invention, there is provided a method of binding of a dual stack terminal when the dual stack terminal has moved from a network to which the dual stack terminal belonged previously to another network to which the dual stack terminal belongs, the binding method including a first MAP, which is a MAP in the network to which the dual stack terminal belonged previously, the first MAP receiving binding information, including information on the dual stack terminal after the moving and information on an access router to which the dual stack terminal belongs, from a second MAP, which is a MAP of the network to which the dual stack terminal belongs; and the first MAP storing and keeping the received binding information as binding information on the dual stack terminal.

According to another aspect of the present invention, there is provided method of transmitting data to a dual stack terminal when the dual stack terminal has moved from a network to which the dual stack network belonged previously, to another network to which the dual stack network belongs, the method including a first MAP, which is a MAP in the network to which the dual stack terminal belonged previously before the moving, and retains binding information, including information on the dual stack terminal after the moving and information on an access router to which the dual stack terminal belongs, the first MAP receiving data to be transmitted to the dual stack terminal; based on the binding information on the dual stack terminal, the first MAP confirming a second MAP, which is a MAP of the network to which the dual stack terminal has moved, and transmitting the data to the second MAP; and the second MAP receiving the transmitted data, transferring the received data to the dual stack terminal through the access router to which the dual stack terminal belongs.

### Advantageous Effects

The apparatus for and method of supporting network-based mobility for a dual stack terminal described above solves the problem of the conventional method in which when a dual stack terminal moves to an IPv4-only network or an IPv6-only network, communication between networks cannot be supported. Accordingly, a dual stack terminal can freely move between IPv4-only networks and IPv6 networks, and seamless communication with an external IPv4 node or IPv6 node is enabled.

### DESCRIPTION OF DRAWINGS

FIG. 1 is a schematic diagram illustrating an environment in which a dual stack terminal (node) moves according to an embodiment of the present invention;

FIG. 2 is a diagram illustrating a mobility anchor point (MAP) apparatus for supporting mobility of a dual stack terminal according to an embodiment of the present invention;

FIG. 3 is a flowchart illustrating a method of binding in relation to a dual stack terminal when the dual stack terminal has moved from one network to another network according to an embodiment of the present invention;

FIG. 4 is a diagram illustrating a message transfer procedure when a dual stack terminal has moved to an Internet Protocol version 4 (IPv4)-only network according to an embodiment of the present invention;

FIG. 5 is a diagram illustrating a message transfer procedure when a dual stack terminal has moved to an Internet Protocol version 6 (IPv6)-only network according to an embodiment of the present invention;

FIG. 6 is a diagram illustrating a process of transmitting data to a dual stack terminal when the dual stack terminal has moved to an IPv4-only network according to an embodiment of the present invention;

FIG. 7 is a diagram illustrating a process of transmitting data to a dual stack terminal when the dual stack terminal has moved to an IPv6-only network according to an embodiment of the present invention; and

FIG. 8 is a flowchart illustrating a process of transmitting data to a dual stack terminal when the dual stack terminal has moved from one network to another network according to an embodiment of the present invention.

### BEST MODE

According to the present invention, a mobility anchor point (MAP) used in a conventional network-based mobility supporting method is extended and named as a global MAP (GMAP). When a mobile node moves between different network-based localized mobility management domains, such as an IPv4-only network or an IPv6-only network, a binding management message is made to be exchanged between two MAPs of the networks, thereby maintaining a binding cache, including information on the mobile node, between the GMAP and the MAP of the network to which the mobile node has moved, and connecting data transmitted to the GMAP through IPv6-in-IPv4 tunneling or IPv4-in-IPv6 tunneling to the MAP. In this way, even when the dual stack terminal moves from one network to another network, such as an IPv4-only network or an IPv6-only network, communication with an external terminal is enabled.

According to an aspect of the present invention, there is provided mobility anchor point (MAP) apparatus for supporting mobility of a dual stack terminal when the dual stack terminal moves from one network to which the dual stack terminal belonged to another network, the MAP apparatus including a storage unit storing binding information, including information on the dual stack terminal after the moving and information on an access router to which the dual stack terminal belongs, which is received from a first MAP, which is a MAP for the network to which the dual stack terminal has moved; and a transmission unit, which when data to be transmitted to the dual stack terminal is received, transmits the received data to the first MAP based on the binding information on the dual stack terminal stored in the storage unit.

According to another aspect of the present invention, there is provided a method of binding of a dual stack terminal when the dual stack terminal has moved from a network to which the dual stack terminal belonged previously to another network to which the dual stack terminal belongs, the binding method including a first MAP, which is a MAP in the network to which the dual stack terminal belonged previously, the first MAP receiving binding information, including information on the dual stack terminal after the moving and information on an access router to which the dual stack terminal belongs, from a second MAP, which is a MAP of the network to which the dual stack terminal belongs; and the first MAP storing and keeping the received binding information as binding information on the dual stack terminal.

According to another aspect of the present invention, there is provided method of transmitting data to a dual stack terminal when the dual stack terminal has moved from a network to which the dual stack network belonged previously, to another network to which the dual stack network belongs, the method including a first MAP, which is a MAP in the network to which the dual stack terminal belonged previously before the moving, and retains binding information, including information on the dual stack terminal after the moving and information on an access router to which the dual stack terminal belongs, the first MAP receiving data to be transmitted to the dual stack terminal; based on the binding information on the dual stack terminal, the first MAP confirming a second MAP, which is a MAP of the network to which the dual stack terminal has moved, and transmitting the data to the second MAP; and the second MAP receiving the transmitted data, transferring the received data to the dual stack terminal through the access router to which the dual stack terminal belongs.

### Mode for Invention

The attached drawings for illustrating preferred embodiments of the present invention are referred to in order to gain a sufficient understanding of the present invention, the merits thereof, and the objectives accomplished by the implementation of the present invention. Hereinafter, the present invention will be described in detail by explaining preferred embodiments of the invention with reference to the attached drawings.

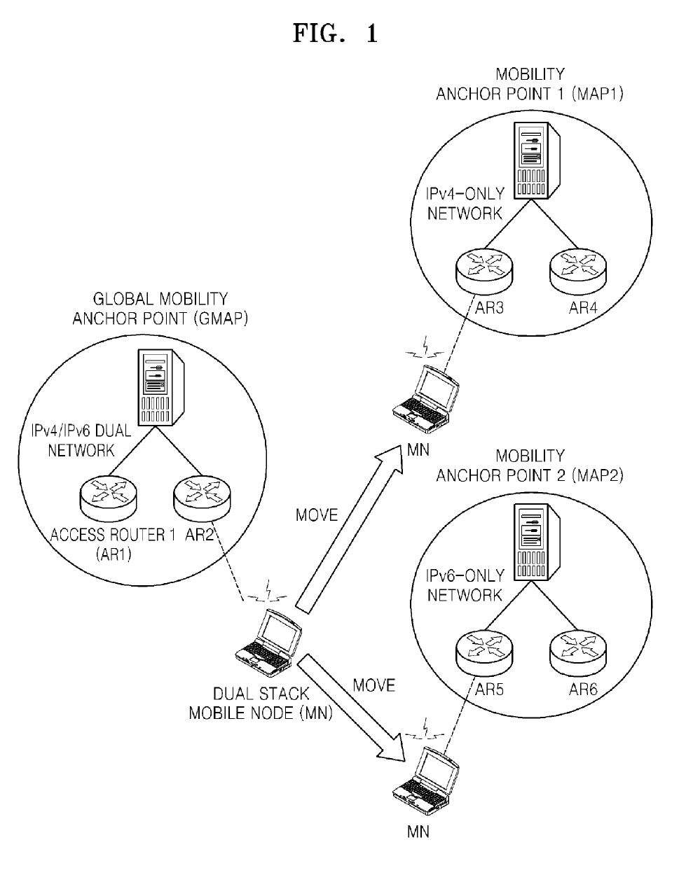

FIG. 1 is a schematic diagram illustrating an environment in which a dual stack terminal (node) moves according to an embodiment of the present invention.

FIG. 1 is a network configuration diagram when a dual stack node to which the present invention is applied moves to an IPv4-only network or an IPv6-only network. Referring to FIG. 1, before moving, the dual stack terminal is positioned in an IPv4/IPv6 dual network, and here, a global mobility anchor point (GMAP) performs management of supporting network-based mobility for the dual stack terminal.

Here, terms that will be frequently used include network-based localized mobility management (NetLMM), dual stack nodes, an IPv4-only network, an IPv6-only network, a mobile node (MN), a corresponding node (CN), binding management, and a binding cache. In particular, the MN indicates a host or terminal which moves a position from which it accesses a network and the CN indicates a host or a terminal communicating with the MN. The concept of binding is matching a home address of an MN to a communication network when the MN has moved to an external network from the communication network.

The current embodiment of the present invention is a method of seamlessly maintaining an existing communication connection, as illustrated in FIG. 1, when an IPv4/IPv6 dual stack terminal in a dual stack network communicating with an external IPv4 or IPv6 node moves from the dual stack network to an IPv4-only network or an IPv6-only network. Cases illustrating the method can be broadly broken down into two cases, case 1 where the dual stack terminal moves to an IPv4-only network and case 2 where the dual stack terminal moves to an IPv6-only network.

In case 1, when the MN has moved to the IPv4-only network, a GMAP which manages the dual stack network before the movement exchanges information of the moved MN, information on an access router corresponding to the MN, and information on the movement to the IPv4-only network, in the form of a binding management message, with a mobility anchor point (MAP) responsible for management of network-based mobility of the IPv4-only network. The GMAP maintains the information in the form of a binding cache.

Accordingly, if actual data is transmitted to the GMAP, the GMAP learns from the binding cache that the MN does not exist under its management and that the MN has moved and is now under management of the new MAP in the IPv4-only network. If the data transmitted to the GMAP is an IPv4 packet, the packet is transmitted to the MAP in the IPv4-only network through IPv4-in-IPv4 tunneling, and if the data is an IPv6 packet, the packet is transmitted to the MAP through IPv6-in-IPv4 tunneling. In this way, even when the dual stack terminal moves to the IPv4-only network, communication can be maintained seamlessly.

In case 2, when the MN has moved to the IPv6-only network, the GMAP which manages the dual stack network before the movement exchanges information of the moved MN, information on an access router corresponding to the MN, and information on the movement to the IPv6-only network, in the form of a binding management message, with a MAP responsible for management of network-based mobility of the IPv6-only network. The GMAP maintains the information in the form of a binding cache.

Accordingly, if actual data is transmitted to the GMAP, the GMAP learns from the binding cache that the MN does not exist under its management and that the MN has moved and is now under management of the new MAP in the IPv6-only network. If the data transmitted to the GMAP is an IPv4 packet, the packet is transmitted to the MAP in the IPv6-only network through IPv4-in-IPv6 tunneling, and if the data is an IPv6 packet, the packet is transmitted to the MAP through IPv6-in-IPv6 tunneling. In this way, even when the dual stack terminal moves to the IPv6-only network, communication can be maintained seamlessly.

As the term ‘tunneling technology’ indicates, a tunnel is made in an IPv4 network and an IPv6 packet is allowed to pass through the IPv4 network, when the IPv6 packet moves from an IPv6 network to another IPv6 network through the IPv4 network. For example, the IPv4/IPv6 dual stack terminal encapsulates IPv6 data in an IPv4 packet, and can transmit the data through an IPv4 routing topology area, by using the tunneling technology.

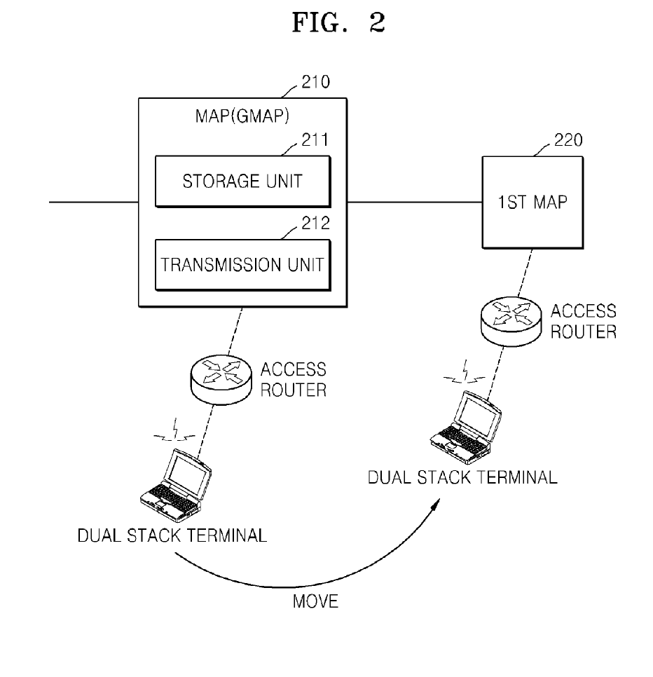

FIG. 2 is a diagram illustrating a MAP apparatus for supporting mobility of a dual stack terminal according to an embodiment of the present invention.

A dual stack terminal moves from an access router to which the dual stack terminal belongs and from a MAP 210 managing the access router, to another network. The structure of the MAP 210 for supporting mobility of the dual stack terminal is illustrated in FIG. 2.

The MAP 210 includes a storage unit 211 storing binding information, including information on the dual stack terminal after the moving and information on an access router to which the dual stack terminal belongs, which is received from a first MAP 220, which is a MAP for the network to which the dual stack terminal has moved. The MAP 210 also includes a transmission unit 212, which when data to be transmitted to the dual stack terminal is received, transmits the data to the first MAP 220 based on the binding information on the dual stack terminal stored in the storage unit 211. With this structure, the MAP 210 performs a role of a GMAP supporting mobility of the dual stack terminal. In particular, the network to which the dual stack terminal belonged before is an IPv4/IPv6 dual network, and the network to which the dual stack terminal has moved is an IPv4 network or an IPv6 network. The storage unit 211 stores the received binding information using a binding cache.

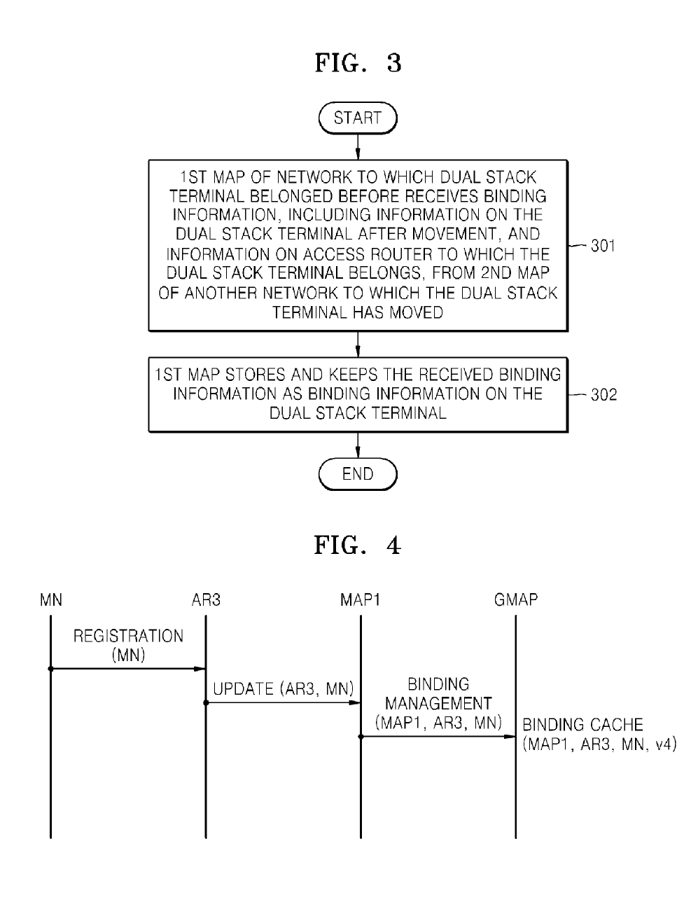

FIG. 3 is a flowchart illustrating a method of binding in relation to a dual stack terminal when the dual stack terminal has moved from one network to another network according to an embodiment of the present invention.

According to the current embodiment, a first MAP, which is a MAP in a network to which the dual stack terminal belonged before, receives binding information, including information on the dual stack terminal after the moving and information on an access router to which the dual stack terminal belongs, from a second MAP, which is a MAP of the network to which the dual stack terminal belongs, in operation 301. Then, the binding information is stored and kept as binding information on the dual stack terminal in operation 302.

FIG. 4 is a diagram illustrating a message transfer procedure when a dual stack terminal has moved to an IPv4-only network according to an embodiment of the present invention.

The message transfer procedure relates to case 1 described above with reference to FIG. 1, and illustrates a process of transferring a binding management message between the GMAP and the MAP1. That is, FIG. 4 illustrates an example of transferring a binding management message between the GMAP and the MAP1 when the MN has moved to the IPv4-only network.

First, if the dual stack node (MN) moves into the IPv4-only network, the MN transmits a registration message to an access router 3 (AR3) according to a network-based mobility support management method. The AR3 receiving the message transmits an Update (AR3, MN) message to the MAP1. The MAP1 receiving the message transfers a binding management (MAP1, AR3, MN) message to the GMAP according to the method of the present invention. The GMAP receiving the message maintains the mobility information of the MN, that is, (MAP1, AR3, MN, v4) information, in the form of a binding cache.

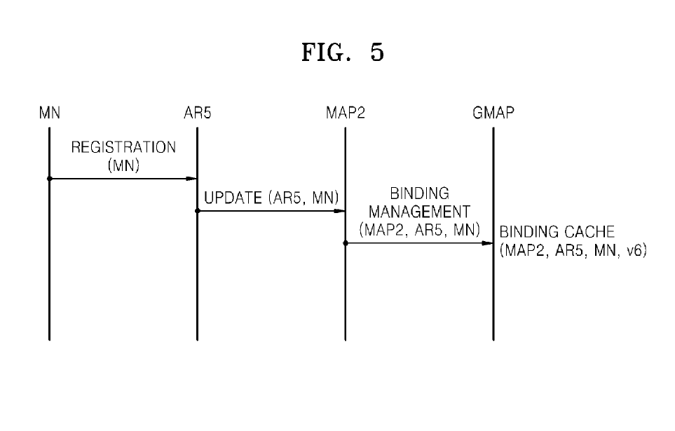

FIG. 5 is a diagram illustrating a message transfer procedure when a dual stack terminal moves to an IPv6-only network according to an embodiment of the present invention.

The message transfer procedure relates to case 2 described above with reference to FIG. 1, and illustrates a process of transferring a binding management message between the GMAP and the MAP2. That is, FIG. 5 illustrates an example of transferring a binding management message between the GMAP and the MAP2 when the MN has moved to the IPv6-only network.

If the dual stack node (MN) moves into the IPv6-only network, the MN first transmits a registration message to an access router 5 (AR5) according to a network-based mobility support management method. The AR5 receiving the message transmits an Update (AR5, MN) message to the MAP2. Then, the MAP2 receiving the message transfers a binding management (MAP2, AR5, MN) message to the GMAP according to the method of the present invention. The GMAP receiving the message maintains the mobility information of the MN, that is, (MAP2, AR5, MN, v6) information, in the form of a binding cache.

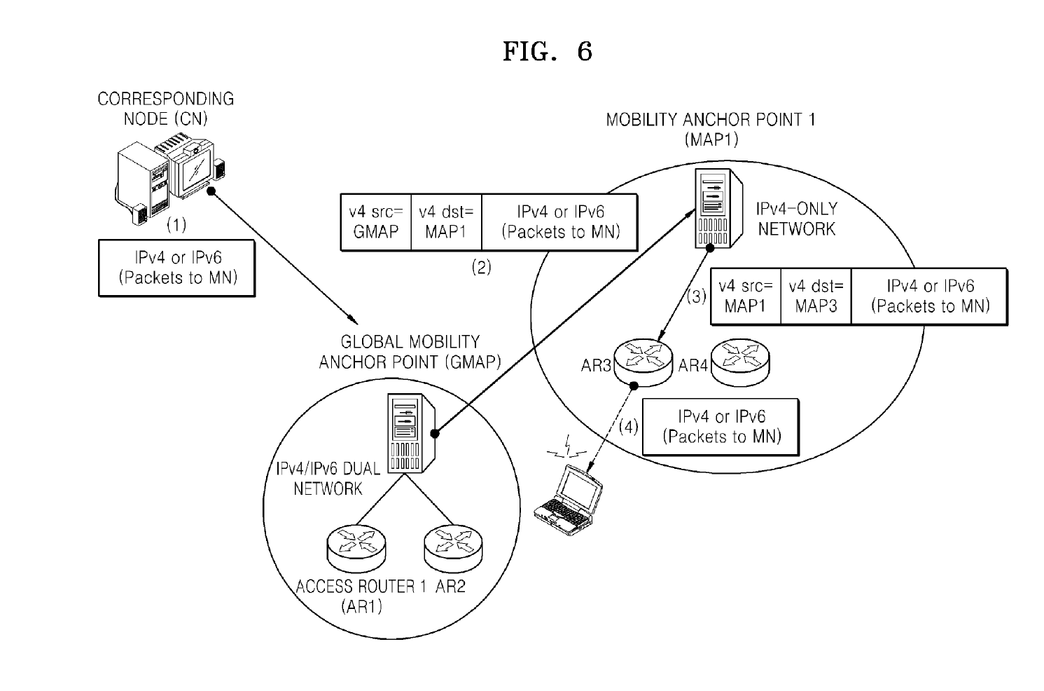

FIG. 6 is a diagram illustrating a process of transmitting data to a dual stack terminal when the dual stack terminal has moved to an IPv4-only network according to an embodiment of the present invention.

FIG. 6 illustrates a process of transmitting a packet when a CN transmits an IPv4 packet or an IPv6 packet to the dual stack node, and shows an example of transferring data when the MN has moved to the IPv4-only network.

Referring to FIG. 6, when the CN transmits an IPv4 packet or an IPv6 packet to the dual stack node, the packet is transmitted to a GMAP. According to binding cache information, the GMAP confirms that the MN is not positioned in the network of the GMAP and has moved into the IPv4-only network managed by MAP1. Then, if the original packet is an IPv4 packet, the GMAP encapsulates the packet for IPv4-in-IPv4 tunneling, and if the original packet is an IPv6 packet, the GMAP encapsulates the packet for IPv6-in-IPv4 tunneling, and then, the GMAP transmits the encapsulated packet to the MAP1. In this case, the v4 transmitter address of the tunneled packet is the GMAP and the v4 receiver address of the packet is the MAP1. If the MAP1 receives the tunneled packet, the MAP1 decapsulates the packet, and transmits the packet to the AR3 through tunneling according a network-based mobility support management method. The AR3 receives the packet and transmits the packet to the MN that is the destination of the packet.

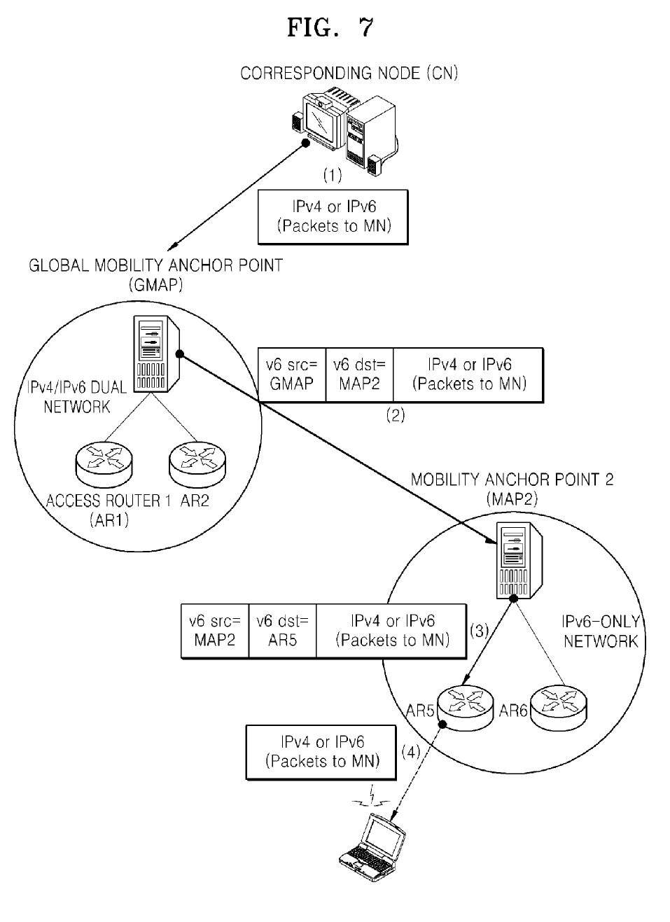

FIG. 7 is a diagram illustrating a process of transmitting data to a dual stack terminal when the dual stack terminal has moved to an IPv6-only network according to an embodiment of the present invention.

FIG. 7 illustrates a process of transmitting a packet when a CN transmits an IPv4 packet or an IPv6 packet to the dual stack node, and shows an example of transferring data when the MN has moved to the IPv6-only network.

Referring to FIG. 7, when the CN transmits an IPv4 packet or an IPv6 packet to the dual stack node, the packet is transmitted to a GMAP. According to binding cache information, the GMAP confirms that the MN is not positioned in the network of the GMAP and has moved into the IPv6-only network managed by MAP2. Then, if the original packet is an IPv4 packet, the GMAP encapsulates the packet for IPv4-in-IPv6 tunneling, and if the original packet is an IPv6 packet, the GMAP encapsulates the packet for IPv6-in-IPv6 tunneling, and then, the GMAP transmits the encapsulated packet to the MAP2. In this case, the v6 transmitter address of the tunneled packet is the GMAP and the v6 receiver address of the packet is the MAP2. If the MAP2 receives the tunneled packet, the MAP2 decapsulates the packet, and transmits the packet to the AR5 through tunneling according a network-based mobility support management method. The AR5 receives the packet and transmits the packet to the MN that is the destination of the packet.

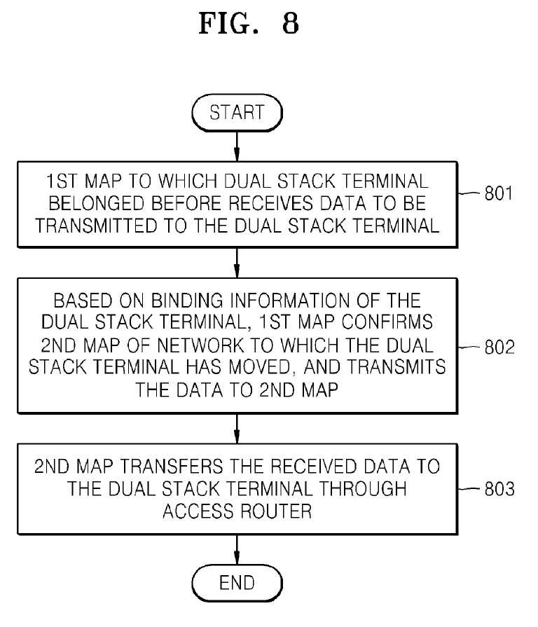

FIG. 8 is a flowchart illustrating a process of transmitting data to a dual stack terminal when the dual stack terminal has moved from one network to another network according to an embodiment of the present invention.

According to the current embodiment, a first MAP, which is a MAP in a network to which the dual stack terminal belonged before the moving and which stores binding information, including information on the dual stack terminal after the moving and information on an access router to which the dual stack terminal belongs, receives data to be transmitted to the dual stack terminal in operation 801. Based on the binding information on the dual stack terminal, the first MAP confirms a second MAP, which is a MAP of the network to which the dual stack terminal has moved, and transmits the data to the second MAP in operation 802. Then, the second MAP transfers the received data to the dual stack terminal through the access router to which the dual stack terminal belongs in operation 803.

The apparatus for and method of supporting network-based mobility for a dual stack terminal described above solves the problem of the conventional method in which when a dual stack terminal moves to an IPv4-only network or an IPv6-only network, communication between networks cannot be supported. Accordingly, a dual stack terminal can freely move between IPv4-only networks and IPv6 networks, and seamless communication with an external IPv4 node or IPv6 node is enabled.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

The present invention provides an apparatus for and method of supporting network-based mobility for a dual stack terminal which moves from one network to another network.

1. A mobility anchor point (MAP) apparatus for supporting mobility of a dual stack terminal when the dual stack terminal moves from one network to which the dual stack terminal belonged to another network, the MAP apparatus comprising:
a storage unit storing binding information, including information on the dual stack terminal after the moving and information on an access router to which the dual stack terminal belongs, which is received from a first MAP, which is a MAP for the network to which the dual stack terminal has moved; and
a transmission unit, which when data to be transmitted to the dual stack terminal is received, transmits the received data to the first MAP based on the binding information on the dual stack terminal stored in the storage unit.

2. The MAP apparatus of claim 1, wherein the network to which the dual stack terminal belonged previously is an Internet Protocol version 4/Internet Protocol version 6 (IPv4/IPv6) dual network, and the other network to which the dual stack terminal has moved is an IPv4 network or an IPv6 network.

3. The MAP apparatus of claim 1, wherein the storage unit stores the received binding information using a binding cache.

4. The MAP apparatus of claim 1, wherein when the transmission unit transmits the data to the first MAP and the other network to which the dual stack terminal has moved is an IPv4 network, if the data is an IPv4 packet, the data is transmitted through IPv4-in-IPv4 tunneling, and if the data is an IPv6 packet, the data is transmitted through IPv6-in-IPv4 tunneling.

5. The MAP apparatus of claim 1, wherein when the transmission unit transmits the data to the first MAP and the other network to which the dual stack terminal has moved is an IPv6 network, if the data is an IPv4 packet, the data is transmitted through IPv4-in-IPv6 tunneling, and if the data is an IPv6 packet, the data is transmitted through IPv6-in-IPv6 tunneling.

6. A method of binding of a dual stack terminal when the dual stack terminal has moved from a network to which the dual stack terminal belonged previously to another network to which the dual stack terminal belongs, the binding method comprising:
a first MAP, which is a MAP in the network to which the dual stack terminal belonged previously, the first MAP receiving binding information, including information on the dual stack terminal after the moving and information on an access router to which the dual stack terminal belongs, from a second MAP, which is a MAP of the network to which the dual stack terminal belongs; and
the first MAP storing and keeping the received binding information as binding information on the dual stack terminal.

7. The method of claim 6, wherein the receiving of the binding information by the first MAP comprises:
the dual stack terminal which has moved to the other network, transmitting a registration message to the access router to which the dual stack terminal belongs after the moving;
based on the registration message, the access router updating information of the second MAP, which is the MAP of the other network to which the dual stack terminal has moved; and
the first MAP, which is the MAP in the network to which the dual stack terminal belonged previously, receiving the binding information, including information on the dual stack terminal after the moving and information on the access router to which the dual stack terminal belongs, in the form of a message from the second MAP with the update information.

8. The method of claim 6, wherein in the storing and keeping of the received binding information by the first MAP, the first MAP stores and keeps the received binding information in a binding cache.

9. The method of claim 6, wherein the network to which the dual stack terminal belonged previously is an IPv4/IPv6 dual network, and the other network to which the dual stack terminal has moved is an IPv4 network or an IPv6 network.

10. A method of transmitting data to a dual stack terminal when the dual stack terminal has moved from a network to which the dual stack network belonged previously, to another network to which the dual stack network belongs, the method comprising:
a first MAP, which is a MAP in the network to which the dual stack terminal belonged previously before the moving and which stores binding information, including information on the dual stack terminal after the moving and information on an access router to which the dual stack terminal belongs, the first MAP receiving data to be transmitted to the dual stack terminal;
based on the binding information on the dual stack terminal, the first MAP confirming a second MAP, which is a MAP of the network to which the dual stack terminal has moved, and transmitting the data to the second MAP; and
the second MAP receiving the transmitted data, transferring the received data to the dual stack terminal through the access router to which the dual stack terminal belongs.

11. The method of claim 10, wherein in the transmitting of the data by the first MAP to the second MAP, when the network to which the dual stack terminal has moved is an IPv4 network, if the data is an IPv4 packet, the data is transmitted through IPv4-in-IPv4 tunneling, and if the data is an IPv6 packet, the data is transmitted through IPv6-in-IPv4 tunneling.

12. The method of claim 10, wherein in the transmitting of the data by the first MAP to the second MAP, when the network to which the dual stack terminal has moved is an IPv6 network, if the data is an IPv4 packet, the data is transmitted through IPv4-in-IPv6 tunneling, and if the data is an IPv6 packet, the data is transmitted through IPv6-in-IPv6 tunneling.
